(19) United States
(12) Patent Application Publication
(10) Pub. No.: US 2016/0289534 A1
(43) Pub. Date: Oct. 6, 2016

(54) DOUBLE HYDROPHILIC BLOCK COPOLYMER ON PARTICULATE SURFACE IN WELLS TO REDUCE SCALE

(71) Applicant: HALLIBURTON ENERGY SERVICES, INC., Houston, TX (US)

(72) Inventors: Lucas Kurtis Fontenelle, Houston, TX (US); Nathan Carl Schultheiss, Kingwood, TX (US); Jimmie Dean Weaver, Jr., Duncan, OK (US)

(21) Appl. No.: 15/037,942

(22) PCT Filed: Dec. 19, 2013
(86) PCT No.: PCT/US2013/076535

§ 371 Date: May 19, 2016

(51) Int. Cl. C09K 8/528; C09K 8/80; E21B 37/06

(52) U.S. Cl. CPC C09K 8/528; E21B 37/06; C09K 8/805; E21B 43/04

(57) ABSTRACT

Methods or systems of protecting against scale formation in a well. The methods or systems include: coating a coating material onto the surface of a particulate, wherein the coating material includes a double hydrophilic block copolymer; and contacting a fluid comprising scale-forming ions with the particulate. The coated particulate can be positioned in the well or a well servicing fluid can be flowed through the coated particulate prior to introducing the fluid into the well.

### CROSS-REFERENCE TO RELATED APPLICATIONS

Not applicable.

### TECHNICAL FIELD

The disclosure is in the field of producing oil or gas from subterranean formations. More specifically, the disclosure generally relates to devices, methods, and systems for use in wells to reduce scale-formation.

### BACKGROUND

Relatively high concentrations of scale-forming ions in a fluid in a well can lead to damage to wellbore servicing equipment, for example, through corrosion or the formation of scale (such as calcite scale, barite scale, or magnesium carbonate scale) on particulate surfaces in a well. Accordingly, there is a need for reducing the accumulation of scale on such surfaces.

### BRIEF DESCRIPTION OF THE DRAWING

The accompanying drawing is incorporated into the specification to help illustrate examples according to a presently preferred embodiment of the disclosure. It should be understood that the figures of the drawing are not necessarily to scale.

FIG. 1 is a schematic illustration of a well operating environment and system.

FIG. 2A is a schematic illustration of a surface wellbore fluid treatment system according to an embodiment of the disclosure.

FIG. 2B is a schematic view of a fluid treatment unit according to an embodiment of the disclosure.

FIG. 3 is an cross-sectional illustration of a particulate, such as downhole in a well, graphically representing the scale-precipitation process and reduction in scale accumulation on a particulate surface having a coating of a material comprising a double hydrophilic block copolymer according to the disclosure.

### DETAILED DESCRIPTION OF PRESENTLY PREFERRED EMBODIMENTS AND BEST MODE

In various embodiments, a method of protecting a surface of a particulate against scale formation in a well is provided, the method comprising: coating a coating material onto the surface of the particulate, wherein the coating material comprises a double hydrophilic block copolymer; and positioning the particulate in the well. Such a method can additionally include, for example, contacting a fluid with the surface of the particulate in the well, wherein the fluid comprises scale-forming ions. The particulate can be, for example, a gravel or proppant.

In various embodiments, a well system is provided, the well system comprising: a particulate positioned in the well system, wherein a surface of the particulate has a coating of a coating material comprising a double hydrophilic block copolymer. Such a well system can additionally include, for example, a fluid in the well system contacting the particulate, wherein the fluid comprises scale-forming ions. The particulate can be, for example, in the wellbore or in a fracture of a subterranean formation in fluid communication with the wellbore. In another example, the particulate can be in a fluid treatment unit operatively connected to the wellbore.

In various embodiments, a method of servicing a well is provided, the method comprising: contacting a fluid with a particulate, wherein the fluid comprises scale-forming ions, and wherein a surface of the particulate has a coating of a coating material comprising a double hydrophilic block copolymer; and introducing the fluid into a wellbore of the well.

These and other embodiments of the disclosure will be apparent to one skilled in the art upon reading the following detailed description. While the disclosure is susceptible to various modifications and alternative forms, specific embodiments thereof will be described in detail and shown by way of example. It should be understood, however, that it is not intended to limit the disclosure to the particular forms disclosed.

### DEFINITIONS AND USAGES

### General Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed. As used herein, the words “consisting essentially of,” and all grammatical variations thereof are intended to limit the scope of a claim to the specified materials or steps and those that do not materially affect the basic and novel characteristic(s) of the claimed invention.

The indefinite articles “a” or “an” mean one or more than one of the component, part, or step that the article introduces.

Each numerical value should be read once as modified by the term “about” (unless already expressly so modified), and then read again as not so modified, unless otherwise indicated in context.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

It should be understood that algebraic variables and other scientific symbols used herein are selected arbitrarily or according to convention. Other algebraic variables can be used.

Terms such as “first,” “second,” “third,” etc. may be assigned arbitrarily and are merely intended to differentiate between two or more components, parts, or steps that are otherwise similar or corresponding in nature, structure, function, or action. For example, the words “first” and “second” serve no other purpose and are not part of the name or description of the following name or descriptive terms. The mere use of the term “first” does not require that there be any “second” similar or corresponding component, part, or step. Similarly, the mere use of the word “second” does not require that there be any “first” or “third” similar or corresponding component, part, or step. Further, it is to be understood that the mere use of the term “first” does not require that the element or step be the very first in any sequence, but merely that it is at least one of the elements or steps. Similarly, the mere use of the terms “first” and “second” does not necessarily require any sequence. Accordingly, the mere use of such terms does not exclude intervening elements or steps between the “first” and “second” elements or steps, etc.

The control or controlling of a condition includes any one or more of maintaining, applying, or varying of the condition. For example, controlling the temperature of a substance can include heating, cooling, or thermally insulating the substance.

### Oil and Gas Reservoirs

In the context of production from a well, “oil” and “gas” are understood to refer to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.”

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

### Well Servicing and Fluids

To produce oil or gas from a reservoir, a wellbore is drilled into a subterranean formation, which may be the reservoir or adjacent to the reservoir. Typically, a wellbore of a well must be drilled hundreds or thousands of feet into the earth to reach a hydrocarbon-bearing formation.

Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a fluid into a well.

A “well” includes a wellhead and at least one wellbore from the wellhead penetrating the earth. The “wellhead” is the surface termination of a wellbore, which surface may be on land or on a seabed.

A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, for example, liquid water or steam, to drive oil or gas to a production wellbore.

Unless otherwise specified, use of the term “wellbore fluid” shall be construed as encompassing all fluids originating from within the wellbore and all fluids introduced or intended to be introduced into the wellbore. Accordingly, the term “wellbore fluid” encompasses, but is not limited to, formation fluids, production fluids, wellbore servicing fluids, the like, and any combinations thereof.

As used herein, introducing “into a well” means introducing at least into and through the wellhead. According to various techniques known in the art, tubulars, equipment, tools, or fluids can be directed from the wellhead into any desired portion of the wellbore.

As used herein, the word “tubular” means any kind of structural body in the general form of a tube. Tubulars can be of any suitable body material, but in the oilfield they are most commonly of metal, most commonly of steel. Examples of tubulars in oil wells include, but are not limited to, a drill pipe, a casing, a tubing string, a liner pipe, and a transportation pipe.

As used herein, the word “treatment” refers to any treatment for changing a condition of a portion of a wellbore or a subterranean formation adjacent a wellbore; however, the word “treatment” does not necessarily imply any particular treatment purpose. A treatment usually involves introducing a fluid for the treatment, in which case it may be referred to as a treatment fluid, into a well. As used herein, a “treatment fluid” is a fluid used in a treatment. The word “treatment” in the term “treatment fluid” does not necessarily imply any particular treatment or action by the fluid.

In the context of a well or wellbore, a “portion” or “interval” refers to any downhole portion or interval along the length of a wellbore.

A “zone” refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to a zone into which a fluid is directed to flow from the wellbore. As used herein, “into a treatment zone” means into and through the wellhead and, additionally, through the wellbore and into the treatment zone.

### Substances, Phases, Physical States, and Materials

A substance can be a pure chemical or a mixture of two or more different chemicals. A pure chemical is a sample of matter that cannot be separated into simpler components without chemical change.

As used herein, “phase” is used to refer to a substance having a chemical composition and physical state that is distinguishable from an adjacent phase of a substance having a different chemical composition or a different physical state.

The word “material” refers to the substance, constituted of one or more phases, of a physical entity or object. Rock, water, air, metal, cement slurry, sand, and wood are all examples of materials. The word “material” can refer to a single phase of a substance on a bulk scale (larger than a particle) or a bulk scale of a mixture of phases, depending on the context.

As used herein, if not other otherwise specifically stated or the context otherwise requires, the physical state or phase of a substance (or mixture of substances) and other physical properties are determined at a temperature of 77° F. (25° C.) and a pressure of 1 atmosphere (Standard Laboratory Conditions) without applied shear.

### Polymers

As used herein, unless the context otherwise requires, a “polymer” or “polymeric material” includes homopolymers, copolymers, terpolymers, etc. In addition, the term “copolymer” as used herein is not limited to the combination of polymers having two monomeric units, but includes any combination of monomeric units, for example, terpolymers, tetrapolymers, etc.

As used herein, “modified” or “derivative” means a chemical compound formed by a chemical process from a parent compound, wherein the chemical backbone skeleton of the parent compound is retained in the derivative. The chemical process preferably includes at most a few chemical reaction steps, and more preferably only one or two chemical reaction steps. As used herein, a “chemical reaction step” is a chemical reaction between two chemical reactant species to produce at least one chemically different species from the reactants (regardless of the number of transient chemical species that may be formed during the reaction). An example of a chemical step is a substitution reaction. Substitution on the reactive sites of a polymeric material may be partial or complete.

### Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, particulate or particulate material refers to matter in the physical form of distinct particles in a solid or liquid state (which means such an association of a few atoms or molecules). As used herein, a particulate is a grouping of particles having similar chemical composition and particle size ranges anywhere in the range of about 10 nanometer to about 3 millimeters, for example, large grains of sand.

A particulate can be of solid or liquid particles. As used herein, however, unless the context otherwise requires, particulate refers to a solid particulate. Of course, a solid particulate is a particulate of particles that are in the solid physical state, that is, the constituent atoms, ions, or molecules are sufficiently restricted in their relative movement to result in a fixed shape for each of the particles.

It should be understood that the terms “particle” and “particulate,” includes all known shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

As used herein, a fiber is a particle or grouping of particles having an aspect ratio L/D greater than 5/1.

### Fluids

A fluid can be a homogeneous or heterogeneous. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, for example, a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of Intermolecular Forces.)

Every fluid inherently has at least a continuous phase. A fluid can have more than one phase. For example, a fluid can be in the form of a suspension (larger solid particles dispersed in a liquid phase), a sol (smaller solid particles dispersed in a liquid phase), or an emulsion (liquid particles dispersed in another liquid phase).

### GENERAL APPROACH

This disclosure provides materials for coating a surface that can be used to control the growth rate and morphology of inorganic crystals such as scale. The material promotes the growth of nanodendritic crystal structures to reduce the buildup of scale on various types of particulate surfaces in a well.

In various embodiments, methods include the use of a applying the coating material according to the disclosure to create a surface that promotes the production of inert microcrystal scale, which will under fluid flow shear break off into nano-sized particulates and not remain deposited/adhered to the surface, thus dramatically reducing the rate of scale deposition on the surface. The methods lead to long-term scale prevention in a well. In various embodiments, a coating material according to the disclosure can be used in a well for the seeding of inorganic crystals of materials such as barium sulfate, calcium sulfate, ferrous, ferrite, phosphate, silicate, and other scale forming ion combinations that may be present in a fluid in a well.

In various embodiments, the coating material can be incorporated onto a surface of a particulate for use in a well system to prevent the buildup of scale on the surface, which scale would restrict fluid flow adjacent to the surface. In various embodiments, the coating material can be used to coat a particulate surface for treating a fluid to help precipitate nano-sized particulates of scale to prevent larger accumulations of scale on other surfaces in a well system.

Scale-forming ions may include, for example, barium ions, calcium ions, magnesium ions, strontium ions, manganese ions, aluminum ions, sulfate ions, ferrous ions, ferrite ions, phosphate ions, silicate, hydrogen carbonate ions, carbonate ions, sodium ions, or any combination thereof.

Relatively large amounts of fluid (for example, water) may be needed for the preparation of wellbore servicing fluids, such as drilling fluid, completion fluid, clean-out fluids, cementitious slurries, stimulation fluids (for example, fracturing or perforating fluids), acidizing fluids, gravel-packing fluids, or the like. Common fluid sources used for preparing wellbore servicing fluids include surface water, municipal water, and water co-produced in the production of oil and gas, hereinafter referred to as produced water. Water obtained from one or more of such sources may contain concentrations of dissolved scale-forming ions. A fluid containing concentrations of dissolved scale-forming ions may adversely affect the intended function of a wellbore servicing fluid formed therefrom and may contribute to the degradation or failure of wellbore servicing equipment in contact with the fluid, such as through corrosion or the formation of scale (for example, in the form of calcium, magnesium carbonates, and other scale-forming ions) on flow surfaces of such wellbore servicing equipment. Further, concentrations of such scale-forming ions may adversely affect the intended function of a wellbore servicing fluid or render the fluid unusable for use in wellbore servicing operations or for use in the production of a wellbore servicing fluid.

### DOUBLE HYDROPHILIC BLOCK COPOLYMERS

A double hydrophilic block copolymer (“DHBC”) is a class of polymer that comprises at least two water-soluble blocks of different chemical nature.

It is believed that a double hydrophilic block copolymer can stabilize the primary nanoparticles building blocks for further structural development avoids uncontrolled aggregation. See, Shu-Hong Yu (2003) Polymer controlled crystallization: shape and size control of advanced inorganic nanostructured materials—1D, 2D nanocrystals and more complex superstructures, L. M. Liz-Marzan and M Giersig (eds.), Low-Dimensional Systems: Theory, Preparation, and Some Applications, Kluwer Academic Publishers, pages 87-105.

In various embodiments, the double hydrophilic block copolymer comprises: a first polymeric block having a first polymeric backbone, wherein the first polymeric backbone is hydrophilic, and a second polymeric block having a second polymeric backbone, wherein the second polymeric backbone is hydrophilic, wherein the first polymeric backbone and the second polymeric backbone are different from each other, and wherein the second polymeric block has or is at least partially functionalized to have one or more polar functional groups.

The first polymeric block is also known as a solvating block because its function is to help the polymer dissolve or be soluble in an aqueous solution.

The second polymeric block is also known as a binding block because its function is to attach to a surface of a scale crystal, which can help control the morphology of the crystal growth. The binding block contains variable chemical patterns that show strong affinity to minerals and have strong interaction with inorganic crystals.

In various embodiments, the polymers are typically rather small, having block lengths in the range of about 1,000 g/mole to about 20,000 g/mole.

In various embodiments, the one or more polar functional groups are selected from the group consisting of: carboxyl (—COOH), acyl chloride (—COCl), sulfonyl hydroxide (—SO₃H), sulfhydryl (—SH), phosphonic acid (—PO₃H₂), amino (—NH₂), primary amino acid (an α-carbon linked to an amino group, a carboxylic acid group, and a hydrogen), secondary amino acid (an α-carbon linked to a primary amino group, a secondary amino group, and a carboxylic acid group), amido (—CONH₂), hydroxy (—OH), and any combination thereof.

### First Polymer Block of DHBC

In various embodiments, the first polymeric backbone is selected from the group consisting of: polyethylene glycol (“PEG”), polyethylene oxide (“PEO”), poly acrylic acid (“PAA”), and polydimethylsiloxane (“PDMS”).

In various embodiments, the first polymeric block has less than about 5% of any of the polar functional groups.

In various embodiments, the first polymeric block does not have any of the polar functional groups.

In various embodiments, the first polymeric backbone has an average molecular weight in the range of about 500 g/mole to about 10,000 g/mole.

### Second Polymer Block of DHBC

In various embodiments, the second polymeric backbone is selected from the group consisting of:
polyethylene imine (“PEI”),
(polyethylene imine)-poly acetic acid (“PEIPA”),
polymethacrylic acid (“PMAA”), and
poly(hydroxyethyl ethylene) (“PHEE”).

In various embodiments, the second polymeric block has at least about 10% polymeric units having the polar functional group.

In various embodiments, the second polymeric backbone has a molecular weight in the range of about 500 g/mole to about 10,000 g/mole.

### Examples of DHBCs

Various types of DHBCs with different functional patterns can be designed and used as crystal modifiers. See, e.g., Shu-Hong Yu (2003) Polymer controlled crystallization: shape and size control of advanced inorganic n anostructured materials—1D, 2D nanocrystals and more complex superstructures, L. M. Liz-Marzan and M Giersig (eds.), Low-Dimensional Systems: Theory, Preparation, and Some Applications, Kluwer Academic Publishers, pages 87-105.

For example, a block copolymer poly(ethylene glycol)-block-poly(methacrylic acid) (PEG-b-PMAA, PEG molecular weight about 3,000 g/mole, 68 monomer units, PMAA molecular weight about 700 g/mole, 6 monomer units) is commercially available from Th. Goldschmidt AG, Essen, Germany. The carboxylic acid groups of this copolymer can be partially phosphonated (for example, about 20%) to give a copolymer with carboxyl and phosphonated groups, PEG-b-PMAA-PO₃H₂, according to methods known in such art, for example, according to the method disclosed in Colfen, H., Antonietti, M. (1998) Crystal design of calcium carbonate microparticles using double-hydrophilic block copolymers, Langmuir 14, 582-589.

A block copolymer containing a poly(ethylene glycol)-block-poly(ethylene imine)-poly(acetic acid) (PEG-b-PEI-(CH₂CO₂H)ₙ, also known as PEG-b-PEIPA, having PEG molecular weight about 5,000 g/mole and PEIPA molecular weight about 1,800 g/mole) can be synthesized according to known chemical methods, for example, according to the methods disclosed by Sedlak, M. Colfen, H. (2001) Synthesis of double-hydrophilic block copolymers with hydrophobic moieties for the controlled crystallization of minerals, Macromol. Chem. Phys. 202, 587-597.

Block copolymers based on PEG-b-PEI with various acidic functional groups such as —COOH, —PO₃H₂, —SO₃H, and —SH, can be synthesized by functionalization of the PEI block according to known chemical methods. For example, ethyl phosphonic acid groups can be added to the PEI block by the Michael-type addition reaction of the amine group to the vinyl activated group of vinylphosphonic acid to give PEG-b-PEI-(CH₂—CH₂—PO₃H₂)ₙ(PEG-b-PEI-PEIPA).

The partially phosphorylated poly(hydroxyethyl ethylene) block copolymer with PEG (PEG-b-PHEE-PO4H2(30%)) can be synthesized according to known chemical methods, for example, according to the method disclosed as Rudloff, J., Antonietti, M., Colfen, H., Pretula, J., Kaluzynski, K., Penczek, S. (2002) Double-hydrophilic block copolymers with monophosphate ester moieties as crystal growth modifiers of CaCO₃, Macromol. Chem. Phys. 203, 627-635.

Such copolymers can be purified, for example, by exhaustive dialysis.

### Coating Material

Coatings comprising such a DHBC and related methods can reduce the need for production-side scale inhibitors.

Such coating materials enable scale prevention as a part of well development strategy, as squeeze radial treatment for scale is not feasible in low permeability reservoirs.

A coating according to the disclosure reduces the need for additional chemicals, improves the environmental sustainability of the service company or the operator.

A coating according to the disclosure provides long-term scale prevention on a particulate in a well.

### Discussion

A coating of a material comprising a double hydrophilic block copolymer material according the disclosure is believed to be effective to reduce the concentration of dissolved multivalent ions, such as hard ions (for example, calcium ions, magnesium ions, iron ions, strontium ions, manganese ions, aluminum ions, sulfate ions, hydrogen carbonate ions, carbonate ions, etc.) present within a solution or composition.

Not intending to be bound by theory, the surface morphology of the coated surface is believed to comprise a great number of nucleation sites that can contribute to the formation of crystals over the coated surface.

Without being bound by any theory, the coating material is believed to convert dissolved multivalent ions into inert crystalline solids. For example, not intending to be bound by theory, the coating material can act as a site for heterogeneous nucleation. For example, the surface geometry of the coating material can provide a lower energy path for the formation of a crystalline solid from a plurality of multivalent (for example, divalent) ions through the process of nucleation. During nucleation on such a coating material on a surface, a nucleus of solute molecules (for example, multivalent ions) is formed and reaches a critical size so as to stabilize within the solvent. Not intending to be bound by theory, once a nucleus has reached the critical size, where the crystalline structure has begun to form, crystal growth of the nucleus may continue until the size of the forming crystal reaches a point where it breaks free from the coating material on the surface. Once the crystal (for example, an inert crystalline solid) has broken free from DHBC coating, it may continue absorbing other dissolved ions within the solvent, acting as a site for homogenous nucleation. Not intending to be bound by theory, crystals formed from the coating material on a surface can be kept in the fluid stream, and with their presence, can further accelerate the conversion of dissolved ions into crystals within the fluid stream. As such, the coating material on the surface can aid in converting dissolved multivalent ions into inert crystalline solids, which may be less than 500 nm in size, which can be carried in the fluid without accumulating as scale on surfaces in a well.

### EXAMPLES

To facilitate a better understanding of the present disclosure, the following examples of certain aspects of some embodiments are given. In no way should the following examples be read to limit, or define, the entire scope of the disclosure.

### Well Operating Environment and System

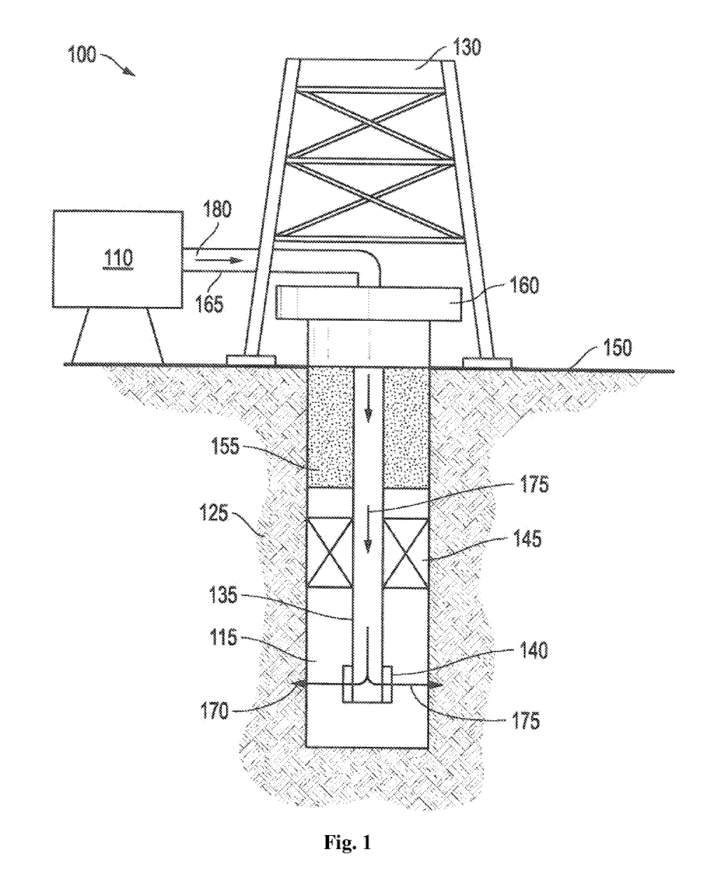

FIG. 1 schematically illustrates a well operating environment and system. In the embodiment of FIG. 1, such an operating environment comprises a well site 100 including a wellbore 115 penetrating a subterranean formation 125 for the purpose of recovering hydrocarbons, storing hydrocarbons, disposing of carbon dioxide, injecting wellbore servicing fluids, or the like.

A surface wellbore fluid treatment (SWFT) system 110 for the treatment of a wellbore servicing fluid (WSF) or a component thereof (for example, water) can be deployed at the well site 100 and is fluidly coupled to the wellbore 115 via a wellhead 160.

The wellbore 115 can be drilled into the subterranean formation 125 using any suitable drilling technique. In an embodiment, a drilling or servicing rig 130 can generally comprise a derrick with a rig floor through which a tubular string 135 (for example, a drill string; a work string, such as a segmented tubing, coiled tubing, jointed pipe, or the like; a casing string; or combinations thereof) may be lowered into the wellbore 115.

A wellbore servicing apparatus 140 configured for one or more wellbore servicing operations (for example, a cementing or completion operation, a clean-out operation, a perforating operation, a fracturing operation, production of hydrocarbons, etc.) can be integrated with or at the end of the tubular string 135 for performing one or more wellbore servicing operations. For example, the wellbore servicing apparatus 140 may be configured to perform one or more servicing operations, for example, fracturing the formation 125, hydrajetting or perforating casing (when present) or the formation 125, expanding or extending a fluid path through or into the subterranean formation 125, producing hydrocarbons from the formation 125, or other servicing operation. In an embodiment, the wellbore servicing apparatus 140 may comprise one or more ports, apertures, nozzles, jets, windows, or combinations thereof suitable for the communication of fluid from a flowpath of the tubular string 135 or a flowpath of the wellbore servicing apparatus 140 to the subterranean formation 125. In an embodiment, the wellbore servicing apparatus 140 is actuatable (for example, openable or closable), for example, comprising a housing comprising a plurality of housing ports and a sleeve being movable with respect to the housing, the plurality of housing ports being selectively obstructed or unobstructed by the sliding sleeve so as to provide a fluid flowpath to or from the wellbore servicing apparatus 140 into the wellbore 115, the subterranean formation 125, or combinations thereof. In an embodiment, the wellbore servicing apparatus 140 may be configurable for the performance of multiple wellbore servicing operations.

Additional downhole tools can be included with or integrated within the wellbore servicing apparatus 140 or the tubular string 135, for example, one or more isolation devices 145 (for example, a packer, such as a swellable or mechanical packer) may be positioned within the wellbore 115 for the purpose of isolating a portion of the wellbore 115.

The drilling or servicing rig 130 can be conventional and can comprise a motor-driven winch and other associated equipment for lowering the tubular string 135 or wellbore servicing apparatus 140 into the wellbore 115. Alternatively, a mobile workover rig, a wellbore servicing unit (for example, coiled tubing units), or the like may be used to lower the tubular string 135 or wellbore servicing apparatus 140 into the wellbore 115 for performing a wellbore servicing operation.

The wellbore 115 may extend substantially vertically away from the earth's surface 150 over a vertical wellbore portion, or may deviate at any angle from the earth's surface 150 over a deviated or horizontal wellbore portion. Alternatively, portions or substantially all of the wellbore 115 may be vertical, deviated, horizontal, or curved.

In various embodiments, the tubular string 135 may comprise a casing string, a liner, a production tubing, coiled tubing, a drilling string, the like, or combinations thereof. The tubular string 135 may extend from the earth's surface 150 downward within the wellbore 115 to a predetermined or desirable depth, for example, such that the wellbore servicing apparatus 140 is positioned substantially proximate to a portion of the subterranean formation 125 to be serviced (for example, into which a fracture 170 is to be introduced).

In some instances, a portion of the tubular string 135 can be secured into position within the wellbore 115 in a conventional manner using cement 155; alternatively, the tubular string 135 may be partially cemented in wellbore 115; alternatively, the tubular string 135 may be uncemented in the wellbore 115.

In an embodiment, the tubular string 135 can comprise two or more concentrically positioned strings of pipe (for example, a first pipe string such as jointed pipe or coiled tubing may be positioned within a second pipe string such as casing cemented within the wellbore).

In an embodiment, the SWFT system 110 can be coupled to the wellhead 160 via a conduit 165, and the wellhead 160 may be connected (for example, fluidly) to the tubular string 135. Flow arrows 180 and 175 indicate a route of fluid communication from the SWFT system 110 to the wellhead 160 via conduit 165, from the wellhead 160 to the wellbore servicing apparatus 140 via tubular string 135, and from the wellbore servicing apparatus 140 into the wellbore 115 or into the subterranean formation 125 (for example, into fractures 170).

It should be understood, of course, that during production of fluid from the subterranean formation, the fluid flows in the reverse direction from the subterranean formation 125, through a wellbore servicing apparatus 140, through tubular string 135, to the wellhead 160, and out via a conduit, such as conduit 165, and beyond.

Although one or more of the figures may exemplify a given operating environment, the principles of the devices, systems, and methods disclosed can be similarly applicable in other operational environments, such as offshore or subsea wellbore applications.

### SWFT System with DHBC Coated Particulate for Treating a Fluid

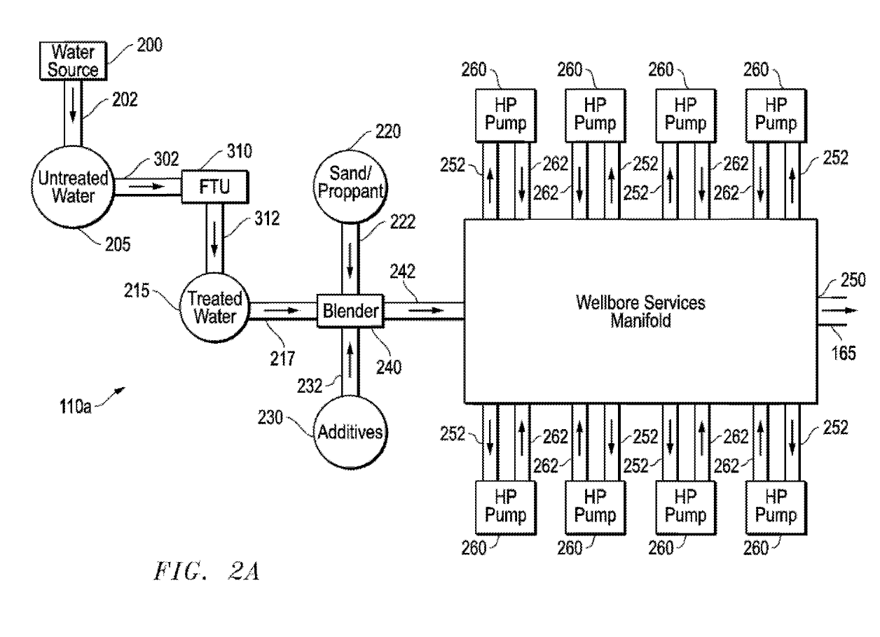

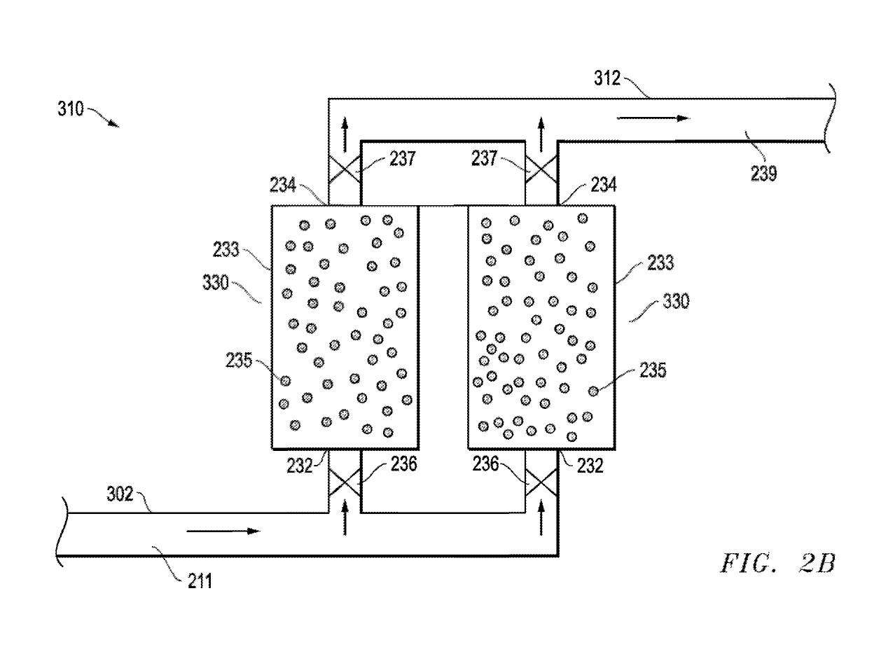

In an embodiment, the SWFT system 110 generally comprises a flowpath in which a WSF or a component thereof is brought into contact with a quantity of DHBC coated particulate. In the embodiment of FIG. 2B, the SWFT system 110 generally comprises a flowpath from (for example, via fluidly connecting) a fluid source 200 (for example, a water source), a fluid treatment unit (“FTU”) 310, one or more storage vessels (such as storage vessels 205, 215, 220, and 230) a blender 240, a wellbore services manifold 250, and one or more high-pressure (HP) pumps 260.

In additional or alternative embodiments, a SWFT system may comprise any suitable additional components, or any suitable combination of any of these or any additional component. Persons of ordinary skill in the art with the aid of this disclosure will appreciate that the flowpaths described herein may include various configurations of piping, tubing, etc. that are fluidly connected, for example, via flanges, collars, welds, etc. These flowpaths may include various configurations of pipe tees, elbows, and the like. These flowpaths fluidly connect the various WSF process equipment described herein.

In an embodiment, a SWFT system such as SWFT system 110 may be configured for any suitable wellbore servicing operation, such as a drilling operation, a hydrajetting or perforating operation, a remediation operation, a fluid loss control operation, a primary or secondary cementing operation, or combinations thereof.

For example, in the embodiment of FIG. 1, the SWFT system is illustrated as configured for a subterranean formation stimulation operation (for example, perforating or fracturing), for example, for initiating, forming, or extending a fracture (such as fractures 170 of FIG. 1) within a hydrocarbon-bearing portion of a subterranean formation (such as subterranean formation 125) or a portion thereof. In such a stimulation operation (for example, a hydraulic fracturing operation), a WSF, such as a particulate (for example, proppant) laden fluid (for example, a fracturing fluid), can be introduced, at a relatively high-pressure, into the wellbore 115. The particulate laden fluids may then be introduced into a portion of the subterranean formation 125 at a rate or pressure sufficient to initiate, create, or extend one or more fractures 170 within the subterranean formation 125. Proppants (for example, grains of sand, glass beads, shells, ceramic particles, etc.,) may be mixed with the WSF, for example, so as to keep the fractures open (for example, to “prop” the fractures) such that hydrocarbons may flow into the wellbore 115 so as to be produced from the subterranean formation 125. Hydraulic fracturing may create high-conductivity fluid communication between the wellbore 115 and the subterranean formation 125, for example, to enhance production of fluids (for example, hydrocarbons) from the formation.

In an embodiment, the fluid source 200 (for example, a water source) can comprise produced water, flowback water, surface water, a water well, potable water, municipal water, or combinations thereof. For example, in an embodiment the water obtained from the fluid source 200 can comprise produced water that has been extracted from the wellbore 115 while producing hydrocarbons from the wellbore 115. As discussed above, produced water for example comprise dissolved scale-forming ions (for example, calcium ions, magnesium ions, iron ions, strontium ions, manganese ions, aluminum ions, sulfate ions, hydrogen carbonate ions, carbonate ions, sodium ions, etc.) or other natural or synthetic constituents that are displaced from a hydrocarbon formation during the production of the hydrocarbons or from a wellbore servicing operation. In an additional or alternative embodiment, water obtained from the fluid source 200 for example comprise flowback water, for example, water that has previously been introduced into the wellbore 115 during a wellbore servicing operation and subsequently flowed back or returned to the surface. In addition, the flowback water for example comprise hydrocarbons, gelling agents, friction reducers, surfactants, or remnants of WSFs previously introduced into the wellbore 115 during wellbore servicing operations.

In another additional or alternative embodiment, water obtained from the fluid source 200 for example comprise local surface water contained in natural or manmade water features (such as ditches, ponds, rivers, lakes, oceans, etc.). Further, water obtained from the fluid source 200 for example comprise water obtained from water wells or a municipal source. Water obtained from the fluid source 200 can, for example, comprise water that originated from near the wellbore 115 or can be water or another liquid (for example, a non-aqueous fluid) that has been transported to an area near the wellbore 115 from any distance. Still further, water or another fluid obtained from the fluid source 200 can comprise water stored in local or remote containers. In some embodiments, water obtained from the fluid source 200 for example comprise any combination of produced water, flowback water, local surface water, municipal water, or container-stored water. As discussed earlier, local surface water, municipal water, water from local or remote containers, etc., for example also include ions, such as scale-forming ions.

In an embodiment, the water from fluid source 200 of FIG. 2A can be introduced via a conduit 202 into an untreated water storage vessel 205 where it can be temporarily stored prior to being pumped to FTU 310 via a conduit 302. Alternatively, water can be, for example, introduced directly from the fluid source 200 into the FTU 310.

In an embodiment, the FTU 310, as will be disclosed herein with reference to FIG. 2B, can be configured to treat a fluid (for example, water) obtained from the fluid source 200 in order to render the water suitable for use in preparing a WSF or for utilization in a wellbore servicing operation. For example, as will be disclosed herein, the FTU 310 can be configured to render inert (for example, by converting into crystals) scale-forming ions that for example negatively affect the performance of the wellbore servicing equipment that the water contacts. In an embodiment, after treatment via the FTU 310, the water can be introduced via a conduit 312 into an intermediate storage vessel 215 for treated water. Alternatively, the water can be routed to one or more other components of the SWFT system 110 or can be used immediately (for example, treated and used in real time) in forming a WSF.

In the embodiment of FIG. 2A, the water can be introduced into a mixer or blender 240 from a storage vessel (for example, the intermediate storage vessel 215 in the embodiment of FIG. 2A) via a conduit 217. Alternatively, water can be, for example, introduced into the blender 240 directly from the FTU 310. In an embodiment, the blender 240 can be configured to mix solid and fluid components to form a well-blended WSF. As depicted in the embodiment of FIG. 2A, water from a storage vessel (for example, storage vessel 215), a WSF component from storage vessel 220, and one or more other components such as additives from storage vessel 230 can be fed into the blender 240 via conduits 217, 222 and 232, respectively. The blender 240 for example can comprise any suitable type or configuration of blender. The mixing conditions of the blender 240, including time period, agitation method, pressure, and temperature of the blender 240, can be chosen by one of ordinary skill in the art with the aid of this disclosure to produce a homogeneous blend having a desirable composition, density, and viscosity. In alternative embodiments, however, sand or proppant (for example, WSF components), water, and additives can be premixed or stored in a storage tank before entering the blender 240. For example, in an embodiment an Advanced Dry Polymer (ADP) blender can be utilized to dry blend one or more dry components, which for example then be dry fed into the blender 240. In another embodiment, additives can be pre-blended with water or other liquids, for example, using a GEL PRO™ blender, which is a commercially available from Halliburton Energy Services, Inc., to form a liquid gel concentrate that can be fed into the blender 240. In the embodiment of FIG. 2A, the blender 240 is in fluid communication with a wellbore services manifold 250 via a conduit 242.

In the embodiments of FIG. 2A, the WSF can be introduced into the wellbore services manifold 250 from the blender 240 via conduit 242. As used herein, the term “wellbore services manifold” can include, for example, a mobile vehicle, such as a truck or trailer, comprising one or more manifolds for receiving, organizing, or distributing WSFs during wellbore servicing operations. In the embodiment illustrated by FIG. 2A, the wellbore services manifold 250 is coupled to eight HP pumps 260 via outlet conduits 252 and inlet conduits 262. In alternative embodiments, however, there can be more or fewer HP pumps 260 used in a wellbore servicing operation. The HP pumps 260 for example comprise any suitable type of high-pressure pump, a non-limiting example of which is a positive displacement pump. Outlet conduits 252 are outlet lines from the wellbore services manifold 250 that supply fluid to the HP pumps 260. Inlet conduits 262 are inlet lines from the HP pumps 260 that supply fluid to the wellbore services manifold 250. In an embodiment, the HP pumps 260 can be configured to pressurize the WSF to a pressure suitable for delivery into the wellhead 160. For example, the HP pumps 260 for example increase the pressure of the WSF to a pressure of about 10,000 p.s.i., alternatively, about 15,000 p.s.i., alternatively, about 20,000 p.s.i. or higher.

From the HP pumps 260, the WSF for example reenter the wellbore services manifold 250 via inlet conduits 262 and be combined so that the WSF for example have a total fluid flow rate that exits from the wellbore services manifold 250 through conduit 165 to the wellbore 115 of between about 1 BPM to about 200 BPM, alternatively from between about 50 BPM to about 150 BPM, alternatively about 100 BPM.

In an embodiment, the WSF comprises a quantity of at least one WSF additive, for example, depending on the wellbore servicing operation. For example, in an embodiment where the wellbore servicing operation comprises a hydraulic fracturing operation, the at least one WSF component for example comprise a quantity of proppant. Non-limiting examples of suitable proppants include resin coated or uncoated sand, sintered bauxite, ceramic materials, glass beads, ground shells, fruit pits, or hulls, resin coated ground shells, fruit pits or hulls, plastics, or combinations thereof. In an embodiment, the proppant can be present within the WSF (for example, a fracturing fluid) in a range from about 0.1 pounds of proppant per gallon of fracturing fluid to about 25 pounds of proppant per gallon of fracturing fluid, alternatively, from about 0.5 pounds/gallon to about 10 pounds/gallon, alternatively, from about 3 pounds/gallon to about 8 pounds/gallon. In an embodiment, the proppant can be present within the WSF (for example, a fracturing fluid) in a range from about 1 pounds of proppant per gallon of fracturing fluid to about 10 pounds of proppant per gallon of fracturing fluid, alternatively, from about 3 pounds/gallon to about 8 pounds/gallon, alternatively, from about 5 pounds/gallon to about 6 pounds/gallon.

In an alternative embodiment, for example, in an embodiment where the wellbore servicing operation comprises a gravel-packing operation, the at least one WSF component for example comprise a quantity of gravel. The gravel particles are sized such that they are small enough to ensure that sand from the formation cannot penetrate the gravel pack formed by the WSF (for example, a gravel-packing fluid). In an embodiment, the gravel can be present in the WSF (for example, a gravel-packing fluid) in a range from about 0.1 pounds of gravel per gallon of gravel packing fluid to about 15 pounds of gravel per gallon of gravel-packing fluid, alternatively, from about 1 pound/gallon to about 12 pounds/gallon, alternatively, from about 5 pounds/gallon to about 8 pounds/gallon.

In other alternative embodiments, the WSF for example comprise any suitable additional type or formulation of fluid as can be suitable for use in a wellbore servicing operation, such as a drilling operation, a hydrajetting or perforating operation, a remediation operation, a fluid loss control operation, a primary or secondary cementing operation, or combinations thereof. For example, in an embodiment, the WSF for example comprise a drilling fluid, a hydrajetting or perforating fluid, a fluid loss control fluid, a remedial fluid, a sealant composition, a cementitious slurry, or combinations thereof. One of skill in the art, upon viewing this disclosure, will recognize one or more WSF components that can be included within the WSF to yield a WSF (for example, of the types set forth herein) so as to be suitable for use in the performance of a wellbore servicing operation.

In an embodiment, the WSF for example further comprise one or more additives. In an embodiment, the one or more additives for example comprise any suitable additive or combination of additives. Non-limiting examples of such additives include, but are not limited to, polymers, crosslinkers, friction reducers, defoamers, foaming surfactants, fluid loss agents, weighting materials, latex emulsions, dispersants, vitrified shale and other fillers such as silica flour, sand and slag, formation conditioning agents, hollow glass or ceramic beads, elastomers, carbon fibers, glass fibers, metal fibers, minerals fibers, of combinations thereof. One of skill in the art will appreciate that one or more of such additives can be added, alone or in combination, and in various suitable amounts to yield a WSF of a desired character or composition.

In an embodiment, the WSF is delivered into either a subterranean formation (for example, formation 125), a wellbore formed within the subterranean formation (for example, wellbore 115), or both. In an embodiment, the step of delivering the WSF into the wellbore, the subterranean formation, or both for example comprise pressurizing the WSF for example, via the operation one or more high-pressure pumps (for example, HP pump 260) and a wellbore manifold (for example, wellbore services manifold) to a pressure suitable for performing the wellbore servicing operation.

For example, in an embodiment where the WSF is utilized in the performance of a fracturing operation, the WSF can be delivered at a pressure and rate sufficient to form or extend a fracture (for example, fracture 170) in a subterranean formation and to deposit a proppant layer or bed (for example, comprising DHBC coated particulate) therein. In another embodiment where the WSF is utilized in the performance of a gravel packing operation, the WSF can be delivered into the wellbore at a pressure and rate suitable for forming a gravel pack (for example, gravel pack 182) comprising the WSF and DHBC coated particulate within the wellbore.

In the embodiment of FIG. 2A, the SWFT system 110 comprises a FTU, for example, a fluidized bed FTU (“FBFTU”) 310 such as shown in FIG. 2B. In an embodiment, the FBFTU 310 can be configured to contact a fluid (for example, from fluid source 200, such as water) and a quantity of DHBC coated particulate, for example, at a rate or ratio sufficient to render inert at least a portion of one or more ionic constituents (for example, scale-forming ions) therefrom. For example, in an embodiment, the FBFTU 310 is configured to lower the concentration of dissolved ions, such as scale-forming ions, within a fluid (for example, from fluid source 200) introduced to the FBFTU 310. The FBFTU 310 can be configured to lower the concentration of dissolved ions, such as scale-forming ions, within a fluid without injecting or dispersing any other fluid or chemical reactant (for example, a water softener) into the fluid stream introduced to the FBFTU 310. Additionally, in an embodiment the FBFTU 310 can be configured to retain the DHBC coated particulate within the FBFTU 310.

The FBFTU 310 can be configured to contact a fluid (for example, from fluid source 200, such as water) and a quantity of DHBC coated particulate 235, for example, at a rate or ratio sufficient to form a fluidized bed between the fluid and the DHBC coated particulate 235 and sufficient to render inert at least a portion of one or more ionic constituents therefrom. In an embodiment, the one or more ionic constituents comprise one or more species of scale-forming ions. For example, in an embodiment, the FBFTU 310 is configured to lower the concentration of scale-forming ions within a fluid (for example, from fluid source 200) introduced to the FBFTU 310. Scale-forming ions suitable for treatment include, but are not limited to calcium ions, magnesium ions, strontium ions, manganese ions, aluminum ions, sulfate ions, hydrogen carbonate ions, carbonate ions, sodium ions, or any combination thereof. Particularly, in an embodiment as will be disclosed herein, the FBFTU 310 can be configured to lower the concentration of scale-forming ions within a fluid without injecting or dispersing any other fluid or chemical reactant (for example, a water softener) into the fluid stream introduced to the FBFTU 310. Additionally, in an embodiment the FBFTU 310 can be configured to retain the DHBC coated particulate 235 within the FBFTU 310 while allowing wellbore fluids, additives, particulate additives having sizes smaller than the DHBC coated particulate, or any combination thereof to enter FBFTU 310, contact DHBC coated particulate 235, and then exit FBFTU 310.

Referring to FIG. 2B, an embodiment of the FBFTU 310 is illustrated. In the embodiment of FIG. 2B, the FBFTU 310 generally comprises at least one vessel 330 including a plurality of DHBC coated particulate 235. For example, in the embodiment of FIG. 2B, the FBFTU 310 comprises two vessels 330; alternatively, a FBFTU for example comprise any suitable number of vessels (for example, one, three, four, five, six, seven, eight, nine, ten, or more vessels). In the embodiment of FIG. 2B, the vessels 330 are arranged in parallel; alternatively, a plurality of vessels can be configured in any suitable arrangement (for example, in series, or both in series and in parallel). In an embodiment, vessels 330 can be oriented vertically, horizontally, or a combination thereof with respect to the surface (for example, the earth's surface 150). In an embodiment, the vessels 330 can be situated on a common structural support, alternatively multiple, separate structural supports. Examples of a suitable structural support or supports for these units can include a trailer, truck, skid, barge, or any combination thereof.

In the embodiment of FIG. 2B, an untreated fluid stream 211 can be introduced into the vessels 330 of FBFTU 310 via the conduit 302. In an embodiment, each of the one or more vessels 330 generally comprises a housing 233 having a cross-sectional area and containing a quantity of DHBC coated particulate 235. The vessels can comprise one or more inlets 232 and one or more outlets 234. In such an embodiment, the vessels 330 are configured such that the DHBC coated particulate 235 can move freely within the confines of vessels 330 and encounter the untreated fluid stream 211. In addition, in such an embodiment, each of the vessels 330 is configured to retain the quantity of DHBC coated particulate 235 therein. For example, in the embodiment of FIG. 2B, DHBC coated particulate 235 moves freely within vessels 330 as they contact untreated fluid stream 211 passing through vessels 330. However, DHBC coated particulate 235 are also prevented or restricted from leaving vessels 330 with the fluid stream 211 to prevent or restrict the loss of any DHBC coated particulate, alternatively, the loss of a substantial amount of the DHBC coated particulate, therefrom. For instance, the vessels can comprise one or more screens, filters, meshes, supports, trays, or combinations therein, which can be placed within the vessels 330, at an inlet 232 or outlet 234 of the vessel, upstream or downstream from the vessel 330, or any combination thereof. In such an embodiment, the pore or opening sizes of such a screen, filter, or mesh can be chosen based on the sizing, type or volume of the DHBC coated particulate within the vessel 330. For instance, in an embodiment, the vessels 330 can contain one or more of a screen, filter, filter or mesh which can have pore/opening size ranging from about 60 mesh to about 10 mesh, alternatively, about 48 mesh, about 40 mesh, about 35 mesh, about 32 mesh, about 30 mesh, about 28 mesh, about 24 mesh, about 22 mesh, about 20 mesh, about 18 mesh, about 16 mesh, about 14 mesh, or about 12 mesh, or combinations thereof. As used herein, the term “mesh” refers to the sizing of a material, according to the standardized Tyler mesh size, that will pass through some specific mesh (for example, such that any particle of a larger size will not pass through this mesh) but will be retained by some specific tighter mesh (for example, such that any particle of a smaller size will pass through this mesh).

In an embodiment, the vessels 330 can be characterized as being sized, for example, to accommodate a desired flow rate. For example, the vessels can be configured to retain a suitable volume of DHBC coated particulate. For example, each of the vessels can comprise DHBC coated particulate ranging from about 25 lbs. to about 300 lbs., alternatively, from about 75 lbs. to about 250 lbs., alternatively, from about 125 lbs. to about 200 lbs. In an embodiment, the vessels can be configured to provide contact between a fluid stream being treated and the quantity of DHBC coated particulate retained therein at a suitable rate or for a suitable duration. For example, the vessels 330 can be characterized as having a flow volume (in which the quantity of DHBC coated particulate 235 is retained) having a suitable length, a suitable cross-section area, and a suitable length to cross-sectional area ratio. As will be appreciated by one of skill in the art upon viewing this disclosure, and not intending to be bound by theory, increases in the length of the flow volume of the vessel 330 can generally increase the duration of the exposure (for example, contact time) of the fluid being treated to the DHBC coated particulate (for example, at a given flow-rate), and increases in the cross-sectional area of the vessel can increase the flow-rate of fluid that can be exposed to the DHBC coated particulate. For example, in an embodiment, the flow volume of the vessels 330 can be in the range of from about 10 gallon to about 200 gallon, alternatively, from about 50 gallon to about 160 gallon, alternatively, from about 90 gallon to about 120 gallon. Also, in an embodiment the cross-sectional area (for example, the area of a cross-section generally perpendicular to the direction of fluid flow) of the vessels 330 can be in the range of from about 120 in² to about 2,000 in², alternatively, from about 250 in² to about 1,800 in², alternatively, from about 450 in² to about 1,500 in², alternatively, from about 600 in² to about 1,000 in². Also, in an embodiment the ratio of length to cross-sectional area of the flow volume of the vessels 330 can be in the range of from about 2:1 to about 1:150, alternatively, from about 1:4 to about 1:1, alternatively, from about 1:3 to about 1:2. In an embodiment, the flow area of each of the vessels 330 can comprise a suitable volume of DHBC coated particulate.

In an embodiment, the FBFTU 310 can be configured such that DHBC coated particulate 235 form a fluidized bed with untreated fluid stream 211 as untreated fluid stream 211 passes through vessels 330. Vessel sizes, vessel geometries, particulate loadings, values of other process parameters relevant to fluidization bed fluidization, or any combination thereof suitable for achieving fluidization between the DHBC coated particulate and an untreated fluid stream at a given fluid flow rate can be determined by one of ordinary skill in the art with the aid of this disclosure. For example, an untreated fluid stream can be flowed via a feed conduit into the bottom of a vertical cylindrical vessel containing DHBC coated particulate. By selecting a vessel having an inner diameter of about 6 inches and a height of about 48 inches, a feed conduit having an inner diameter of about 1 inch, and a quantity of the DHBC coated particulate in a range of from about 30% to about 75%, a fluidized bed can be achieved at untreated fluid feed rates of about 50 gallons/minute (gal/min). In an embodiment, each of vessels 330 can be loaded with a suitable volume of loose DHBC coated particulate to provide optimal fluidization for an anticipated fluid flow rate through vessels 330.

For example, the vessels can each comprise a volume of DHBC coated particulate of from about 200 in³ to about 18,000 in³, alternatively, from about 720 in³ to about 9,000 in³, alternatively, from about 2,000 in³ to about 6,000 in³. Thus, the FBFTU 310 can be sized to treat a suitable volume of fluid (for example, untreated water), for example, the FBFTU 310 can be configured for the treatment of from about 100 gal/min to 2,000 gal/min, alternatively, from about 150 gal/min to about 1,000 gal/min. Not wishing to be bound by theory, it is believed that mechanical action of the induced turbulence of the wellbore fluid, alone or further enhanced by fluidized bed conditions, maintains an increased proportion of the crystalline solids in an agitated state. As a result, the crystalline solids remained in solution to a greater extent than, for example, laminar flow regimes, thereby further reducing the formation of scale on pipes and other wellbore servicing equipment that the wellbore fluid comes into contact with.

In an embodiment, each vessel 330 can further include an inlet valve 236 and an outlet valve 237. Inlet valves 236 and outlet valves 237 can allow for the flow rate through each of the vessels 330 to be controlled independently or for an individual vessel 330 to be isolated (for example, allowing for the total flow rate via the FBFTU 310 to be scaled-up or scaled-down or allowing for maintenance such as DHBC coated particulate change-outs during ongoing fluid treatment operations).

In an embodiment, the FBFTU 310 can further comprise one or more filtration devices, for example, located upstream from the one or more vessels 330. In such an embodiment, the filtration device can be configured to remove particulate material, sediment, or various other contaminants from a fluid stream, for example, prior to introduction of the fluid stream into the vessels 330.

In an embodiment, the pH of the one or more streams can be monitored. For example, in an embodiment, the pH of the untreated fluid stream 211 can be monitored prior to being introduced into the vessels 330. In addition, if the pH of the fluid stream is not within a suitable pH range, the pH of the water can be adjusted. Such a suitable pH can be from about 6.0 to about 9.0, alternatively, from about 6.5 to about 8.5, alternatively, from about 7.0 to about 8.0. In such an embodiment, the pH can be adjusted via the introduction of an additive, such as one or more of various basic or acidic compositions, as can be appreciated by one of skill in the art with the aid of this disclosure, for example, to bring the pH of the water stream within the desired pH range.

Referring to FIGS. 2A and 2B, while in the embodiment of FIG. 2A a single FBFTU 310 is shown upstream of the blender 240, in alternative embodiments a plurality of FBFTUs can be employed or one or more FBFTUs can be located in alternative positions within the SWFT system 110. For example, one or more FBFTUs can be located upstream of the blender (for example, as shown in FIG. 2A), one or more FBFTUs can be located downstream of the bender, or both. In an embodiment, one or more FBFTUs are used to form treated water, and the treated water can be used in a variety of additional operations, for example as a component in preparing one or more wellbore servicing fluids (for example, prepared in blender 240). Additionally or alternative, upon preparation of a WSF or component there (for example, a treated or untreated fluid such as water combined with one or more additional WSF components such as gels, proppants, etc.), such prepared WSF or component thereof can be further treated via a FBFTU of the type described herein. For instance, in an embodiment the FBFTU 310 can be located downstream from a first blender like blender 240 and, optionally, upstream from a second blender. In such an embodiment, a fluid stream comprising one or more pre-blended WSF components can be introduced into the FBFTU 310 for treatment. Also, in such an embodiment, the FBFTU 310 is configured to reduce the concentration of dissolved ions, such as scale-forming ions, within the fluid. Accordingly, FBFTUs of the type described herein can be used to treat a component of a WSF (for example, water), to treat a WSF (for example, a fracturing fluid, for example an aqueous gel system prior to addition of proppant), or combinations thereof.

While in the embodiment of FIG. 2B, the FBFTU 310 comprises a vessel 330, in an alternative embodiment the FBFTU 310 can comprise other wellbore servicing equipment configured to provide contact between a fluidized, percolating, or otherwise mobile/moving quantity of DHBC coated particulate and a fluid stream (for example, untreated fluid stream 211). For example, the FBFTU 310 can comprise other types of wellbore servicing equipment that can be configured to contact a fluid stream with a fluidized, percolating, or otherwise mobile/moving quantity of DHBC coated particulate, such as a pressure vessel, a water storage tank, or combinations thereof.

In an embodiment, the DHBC coated particulate can be effective to reduce the concentration of dissolved ions, such as scale-forming ions (for example, calcium ions, magnesium ions, iron ions, strontium ions, manganese ions, aluminum ions, sulfate ions, hydrogen carbonate ions, carbonate ions, sodium ions, etc.), present within a solution or composition. In an embodiment, the DHBC coated particulate can be characterized as having a size (for example, a diameter) of ranging from about 0.500 millimeters (mm) to about 0.900 mm, alternatively, from about 0.550 mm to about 0.850 mm, alternatively, from about 0.600 mm to about 0.800 mm. In an embodiment, the quantity of particulate can be characterized as having a mesh size ranging from about 20/40 mesh to about 16/30 mesh. As used herein, the term “mesh” refers to the sizing of a material, according to the standardized Tyler mesh size, will pass through some specific mesh (for example, such that any particle of a larger size will not pass through this mesh) but will be retained by some specific tighter mesh (for example, such that any particle of a smaller size will pass through this mesh.

### Packer with DHBC Coated Particulate for Treating a Fluid

In an embodiment and referring back to FIG. 1, the servicing apparatus 140 can comprise a packer containing DHBC coated particulate within a lining (for example, an annular space such as annular space described herein) of the packer. In an embodiment, a portion of the packer (for example, a sub-assembly) of the packer with additional components such as a plurality of sealing elements and a slip-wedge system for gripping the wellbore and setting the packer. The production packer may be inserted into a wellbore during the course of or in anticipation of a production phase of the wellbore. The production packer may be designed, placed, configured, or any combination thereof such that at least a portion of production fluids emerging from production zones of the subterranean formation of the wellbore pass through the lining, contact the DHBC coated particulate, and form a fluidized bed comprising the production fluids and the DHBC coated particulate before flowing to the surface through a production string flowbore. The production packer may be designed, placed, configured, or any combination thereof such that at least a portion of one or more wellbore servicing fluids introduced into the wellbore, the production zone, the subterranean formation, or any combination thereof via the production packer passes through the lining, contacts the DHBC coated particulate, and forms a fluidized bed with the DHBC coated particulate. In an exemplary embodiment, the wellbore servicing apparatus 140 is placed within a production zone of a wellbore as a production packer.

### Graphical Representation of Precipitation Process in a Particulate

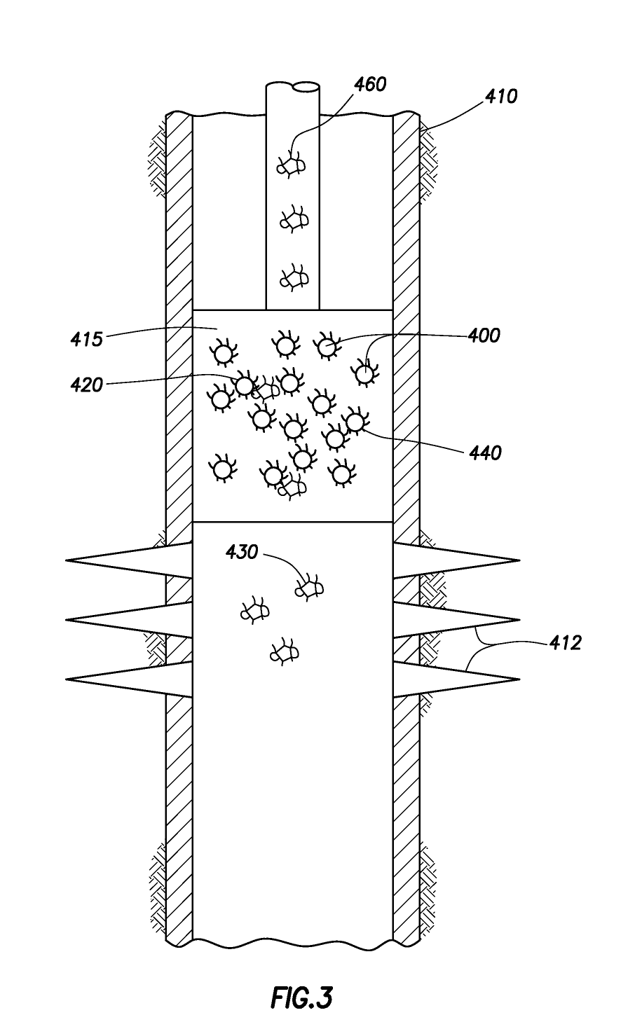

FIG. 3 is a cross-sectional illustration of a particulate 400, such as positioned as a pack or moving in a fluid in a downhole tubular 410 having perforations 412 or in a downhole tool 415 in a wellbore, graphically representing:
(a) a coating material 440 forming nano-structures on a surface of the particulate;
(b) precipitation of mineral material 420 from scale-forming ions onto the nano-structures of the coating material 440; and
(c) breaking-off of nano-sized pieces such as 430 or 460 comprising scale precipitated onto the fragile nano-structures of the coating material.

### CONCLUSION

Therefore, the present disclosure is well adapted to attain the ends and advantages mentioned as well as those that are inherent therein.

The exemplary polymeric materials disclosed herein may directly or indirectly affect one or more components or pieces of equipment associated with the preparation, delivery, recapture, recycling, reuse, or disposal of the disclosed polymer materials. For example, the disclosed polymeric materials may directly or indirectly affect one or more mixers, related mixing equipment, mud pits, storage facilities or units, fluid separators, heat exchangers, sensors, gauges, pumps, compressors, and the like used generate, store, monitor, regulate, or recondition the exemplary polymeric materials. The disclosed polymeric materials may also directly or indirectly affect any transport or delivery equipment used to convey the polymeric materials to a well site or downhole such as, for example, any transport vessels, conduits, pipelines, trucks, tubulars, or pipes used to fluidically move the polymeric materials from one location to another, any pumps, compressors, or motors (for example, topside or downhole) used to drive the polymeric materials into motion, any valves or related joints used to regulate the pressure or flow rate of the polymeric materials, and any sensors (i.e., pressure and temperature), gauges, or combinations thereof, and the like. The disclosed polymeric materials may also directly or indirectly affect the various downhole equipment and tools that may come into contact with the polymeric materials such as, but not limited to, drill string, coiled tubing, drill pipe, drill collars, mud motors, downhole motors or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

The particular embodiments disclosed above are illustrative only, as the present disclosure may be modified and practiced in different but equivalent manners apparent to those skilled in the art having the benefit of the teachings herein. It is, therefore, evident that the particular illustrative embodiments disclosed above may be altered or modified and all such variations are considered within the scope of the present disclosure.

The various elements or steps according to the disclosed elements or steps can be combined advantageously or practiced together in various combinations or sub-combinations of elements or sequences of steps to increase the efficiency and benefits that can be obtained from the disclosure.

It will be appreciated that one or more of the above embodiments may be combined with one or more of the other embodiments, unless explicitly stated otherwise.

The illustrative disclosure can be practiced in the absence of any element or step that is not specifically disclosed or claimed.

Furthermore, no limitations are intended to the details of construction, composition, design, or steps herein shown, other than as described in the claims.

What is claimed is:

1. A method of protecting a surface of a particulate against scale formation in a well, the method comprising:
coating a coating material onto the surface of the particulate, wherein the coating material comprises a double hydrophilic block copolymer; and
positioning the particulate in the well.

2. The method according to claim 1, additionally comprising:
contacting a fluid with the surface of the particulate in the well, wherein the fluid comprises scale-forming ions.

3. The method according to claim 1, wherein the particulate is a proppant.

4. A well system comprising:
a particulate positioned in the well system, wherein a surface of the particulate has a coating of a coating material comprising a double hydrophilic block copolymer.

5. The well system according to claim 4, additionally comprising a fluid in the well system contacting the particulate, wherein the fluid comprises scale-forming ions.

6. The well system according to claim 4, wherein the particulate is in the wellbore or in a fracture of a subterranean formation in fluid communication with the wellbore.

7. The well system according to claim 4, wherein the particulate is in a fluid treatment unit operatively connected to the wellbore.

8. A method of servicing a well, the method comprising:
contacting a fluid with a particulate,
wherein the fluid comprises scale-forming ions, and
wherein a surface of the particulate has a coating of a coating material comprising a double hydrophilic block copolymer; and
introducing the fluid into a wellbore of the well.

9. The method according to claim 1, wherein the double hydrophilic block copolymer comprises:
a first polymeric block having a first polymeric backbone, wherein the first polymeric backbone is hydrophilic; and
a second polymeric block having a second polymeric backbone, wherein the second polymeric backbone is hydrophilic, wherein the first polymeric backbone and the second polymeric backbone are different from each other, and wherein the second polymeric block has or is at least partially functionalized to have one or more polar functional groups.

10. The method according to claim 9, wherein the one or more polar functional groups are selected from the group consisting of: carboxyl (—COOH), acyl chloride (—COCl), sulfonyl hydroxide (—SO₃H), sulfhydryl (—SH), phosphonic acid (—PO₃H₂), amino (—NH₂), primary amino acid (an α-carbon linked to an amino group, a carboxylic acid group, and a hydrogen), secondary amino acid (an α-carbon linked to a primary amino group, a secondary amino group, and a carboxylic acid group), amido (—CONH₂), hydroxy (—OH), and any combination thereof.

11. The method according to claim 10, wherein the first polymeric backbone is selected from the group consisting of: polyethylene glycol (“PEG”), polyethylene oxide (“PEO”), poly acrylic acid (“PAA”), and polydimethylsiloxane (“PDMS”).

12. The method according to claim 10, wherein the first polymeric block has less than about 5% of any of the polar functional groups.

13. The method according to claim 10, wherein the first polymeric block does not have any of the polar functional groups.

14. The method according to claim 10, wherein the first polymeric backbone has an average molecular weight in the range of about 500 g/mole to about 10,000 g/mole.

15. The method according to claim 10, wherein the second polymeric backbone is selected from the group consisting of:
polyethylene imine (“PEI”),
(polyethylene imine)-poly acetic acid (“PEIPA”),
polymethacrylic acid (“PMAA”), and
poly(hydroxyethyl ethylene) (“PHEE”).

16. The method according to claim 10, wherein the second polymeric block has at least about 10% polymeric units having the polar functional group.

17. The method according to claim 10, wherein the second polymeric backbone has a molecular weight in the range of about 500 g/mole to about 10,000 g/mole.

18. The method according to claim 1, wherein the scale-forming ions are selected from the group consisting of: calcium, magnesium, barium, strontium, sulfate, carbonate, bicarbonate, ferrous, ferrite, phosphate, silicate, and any combination thereof.

19. The well system according to claim 4, wherein the double hydrophilic block copolymer comprises:
a first polymeric block having a first polymeric backbone, wherein the first polymeric backbone is hydrophilic; and
a second polymeric block having a second polymeric backbone, wherein the second polymeric backbone is hydrophilic, wherein the first polymeric backbone and the second polymeric backbone are different from each other, and wherein the second polymeric block has or is at least partially functionalized to have one or more polar functional groups.

20. The well system according to claim 19, wherein the one or more polar functional groups are selected from the group consisting of: carboxyl (—COOH), acyl chloride (—COCl), sulfonyl hydroxide (—SO₃H), sulfhydryl (—SH), phosphonic acid (—PO₃H₂), amino (—NH₂), primary amino acid (an α-carbon linked to an amino group, a carboxylic acid group, and a hydrogen), secondary amino acid (an α-carbon linked to a primary amino group, a secondary amino group, and a carboxylic acid group), amido (—CONH₂), hydroxy (—OH), and any combination thereof.
